(19) United States
(12) Patent Application Publication
(10) Pub. No.: US 2011/0262678 A1
(43) Pub. Date: Oct. 27, 2011

(54) OPTICAL INFORMATION RECORDING MEDIUM

(75) Inventors: Yo Ota, Kanagawa (JP); Takashi Iwamura, Kanagawa (JP)

(73) Assignee: SONY CORPORATION, Tokyo (JP)

(21) Appl. No.: 13/082,592

(22) Filed: Apr. 8, 2011

(30) Foreign Application Priority Data
Apr. 21, 2010 (JP) 2010-098018

(51) Int. Cl. G11B 7/251

(52) U.S. Cl. 428/64.7; 428/64.4; 428/65.1

(57) ABSTRACT

An optical information recording medium includes a recording layer, wherein the recording layer includes a thermoplastic resin and inorganic oxide particles dispersed in the thermoplastic resin.

### BACKGROUND OF THE INVENTION

1. Field of the Invention

The present invention relates to an optical information recording medium in which information is recorded using a light beam and from which the information is reproduced using a light beam.

2. Description of the Related Art

Typical examples of an optical information recording medium include a compact disc (CD), a digital versatile disc (DVD), and a Blu-ray Disc (registered trademark, hereinafter referred to as BD). In optical information recording media, there are recorded various kinds of information including various contents, such as music contents and video contents, and various data for use in a computer. In recent years, the amount of information to be recorded has increased in accordance with the increase in the definition of video and the sound quality of music. In addition, there has been a demand to increase the number of contents that can be recorded in a single optical information recording medium. Therefore, optical information recording media having larger capacities have been demanded.

To increase the capacity of an optical information recording medium, there is proposed an optical information recording medium having a configuration in which information can be three-dimensionally recorded in a thickness direction of the optical information recording medium (e.g., refer to Japanese Unexamined Patent Application Publication No. 2005-37658). In this optical information recording medium, a recording layer contains a two-photon absorption material that is foamed in response to two-photon absorption. By irradiating the recording layer with a light beam, a two-photon absorption material is foamed and thus recording marks composed of air bubbles (holes) are formed.

Two-photon absorption, which is a type of third-order nonlinear optical effect, is a phenomenon in which a single molecule is excited through virtual levels by simultaneously absorbing two photons. The probability of two-photon absorption increases in proportion to the square of electric field intensity (that is, light intensity). Thus, in an optical information recording medium containing a two-photon absorption material in a recording layer (hereinafter referred to as two-photon absorption recording medium), two-photon absorption occurs only near a focal point having the highest electric field intensity. On the other hand, two-photon absorption does not occur in portions other than one at the focal point, such portions having low electric field intensity. That is, a laser beam travels through the recording layer with little absorption until the laser beam reaches the focal point and then undergoes two-photon absorption by a two-photon absorption material when the laser beam reaches the focal point.

In the case of a typical recording layer that uses one-photon absorption, a laser beam is absorbed in the entire region of the recording layer and therefore the light intensity of the laser beam is decreased by the time when the laser beam reaches a deep portion of the recording layer. Thus, in the typical recording layer that uses one-photon absorption, it is difficult to form a recording layer, for example, having ten or more sub-layers.

In contrast, in the two-photon absorption recording medium, since a laser beam reaches a focal point with little absorption, it is possible to form a recording layer having ten or more sub-layers.

It is obvious that the shape of a recording mark formed in a recording layer of an optical information recording medium affects the waveform of a reproduction signal. For example, assuming the case where a recording mark having the same length in a reproduction direction is formed, the shape of a reproduction signal is different between the case where a plurality of recording marks each having a small diameter are intermittently formed and the case where a continuous recording mark having the same length as that of the plurality of recording marks is formed.

FIG. 6 shows a specific relationship between a reproduction signal and the shape of a recording mark composed of a hole. When recording marks 15A each having a small diameter and being composed of a hole are intermittently formed in a recording layer 11, a rectangular reproduction signal 22 is obtained. On the other hand, when a recording mark 15B having the same length is formed in an elliptical shape that extends in the reproduction direction, the peak is high compared with the case where recording marks each having a small diameter are intermittently formed and the reproduction signal 22 becomes mountain shaped.

### SUMMARY OF THE INVENTION

In the two-photon absorption recording medium, when a recording mark is formed by irradiating a recording layer with a light beam, part of a photoreactive resin is boiled or decomposed due to the heat generated through a photoreaction and thus a hole is formed. FIGS. 7A to 7C show the mechanism from the irradiation of a recording layer 11 with a light beam L to the formation of a recording mark 15 composed of a hole.

An irradiation point 16 of a recording layer 11 is irradiated with a light beam L (FIG. 7A). As shown in FIG. 7B, a hole is formed at the irradiation point 16 due to the boiling or decomposition of a resin. The heat generated at the irradiation point 16 is propagated to the surroundings of the irradiation point 16 and a region 17 having a temperature higher than or equal to the melting temperature of the resin is formed. Normally, a two-photon absorption material that constitutes the recording layer is formed of a thermoplastic resin as a basic skeleton. Thus, if the region 17 is formed in which the thermoplastic resin is heated to a temperature higher than or equal to the melting temperature thereof due to the heat propagated to the surroundings of the irradiation point 16, the resin in the region 17 is fluidized.

The fluidized thermoplastic resin is affected by the pressure and surface tension of an air bubble formed. Therefore, as shown in FIG. 7C, the shape of the hole changes to a substantially spherical shape from the shape obtained through the irradiation with the light beam, and a recording mark 15 is formed. Herein, it is believed that the recording mark 15 is enlarged up to substantially the same size as that of the above-described region 17 having a temperature higher than or equal to the melting temperature of the resin.

As described above, by irradiating the recording layer with the light beam L, the two-photon absorption material is boiled or decomposed in the recording layer 11 and sequentially the thermoplastic resin is fluidized, whereby the recording mark 15 is formed.

However, in the case where recording marks each having a small diameter are intermittently formed in the recording layer as described above to obtain a rectangular recording signal, adjacent recording marks are integrated when the thermoplastic resin is fluidized and the hole is deformed. As a result, the adjacent recording marks are changed into a continuous recording mark.

FIGS. 8A to 8C show the mechanism with which the recording mark is deformed by the integration of adjacent holes.

As shown in FIG. 8A, two adjacent irradiation points 16 of a recording layer 11 are irradiated with a light beam L. Herein, regions 17 each having a temperature higher than or equal to the melting temperature of the resin are formed in the surroundings of the two irradiation points 16. If the irradiation points 16 are closely located so that the respective regions 17 overlap each other, as shown in FIG. 8B, the holes formed at the irradiation points 16 are enlarged while at the same time the holes are moved so as to come close to each other. Consequently, as shown in FIG. 8C, the two holes are integrated to form a single continuous recording mark 15.

If the recording mark is deformed in such a manner, the waveform of a reproduction signal is deformed and thus a desired reproduction signal is not obtained.

To improve the recording density of an optical information recording medium, recording marks have to be brought closer to each other. If recording marks are brought close to each other, the integration of adjacent recording marks due to the fluidization of the thermoplastic resin is more easily caused and thus such recording marks are deformed into a continuous recording mark. When recording marks are closely formed, a desired reproduction signal is not obtained, which inhibits the improvement in recording density.

A melting temperature of a resin means a melting point in the case where the thermoplastic resin has a melting point like a crystalline resin or means a glass transition temperature (Tg) in the case where the thermoplastic resin does not have a melting point like an amorphous resin.

According to an embodiment of the present invention, there is provided an optical information recording medium whose recording density can be improved and a method for producing the optical information recording medium.

An optical information recording medium according to an embodiment of the present invention includes a recording layer, wherein the recording layer includes a thermoplastic resin and inorganic oxide particles dispersed in the thermoplastic resin.

A method for producing an optical information recording medium according to an embodiment of the present invention includes the steps of dispersing particles of an inorganic oxide in a solvent to prepare a dispersion medium of the inorganic oxide, dissolving a thermoplastic resin in the dispersion medium to prepare a resin solution, and applying the resin solution on a base to form a recording layer.

According to the optical information recording medium and the method for producing the optical information recording medium according to an embodiment of the present invention, there is provided a recording layer including inorganic oxide particles dispersed in a thermoplastic resin.

By dispersing an inorganic oxide having a thermal conductivity higher than that of a thermoplastic resin, the heat generated through the irradiation with a light beam is absorbed and spread by the inorganic oxide. Thus, the size of a region having a temperature higher than or equal to the melting temperature of the thermoplastic resin can be decreased, and the deformation of a recording mark caused by fluidization can be suppressed.

Accordingly, recording marks can be formed so as to be brought closer to each other and the recording density of the optical information recording medium can be improved.

According to an embodiment of the present invention, there can be provided an optical information recording medium whose recording density can be improved and a method for producing the optical information recording medium.

### BRIEF DESCRIPTION OF THE DRAWINGS

FIG. 1 shows an optical information recording medium according to an embodiment of the present invention;

FIG. 2 is a sectional view of the optical information recording medium shown in FIG. 1;

FIG. 3 is a diagram for describing the recording/reproducing principle of a recording mark in the optical information recording medium;

FIGS. 4A to 4C are diagrams for describing the mechanism with which a recording mark is formed, the mechanism being achieved by dispersing an inorganic oxide in a recording layer;

FIG. 5 is a flowchart for describing a method for producing an optical information recording medium according to an embodiment;

FIG. 6 shows a relationship between a reproduction signal and the shape of a recording mark;

FIGS. 7A to 7C are diagrams for describing the mechanism with which a recording mark composed of a hole is formed in a recording layer; and

FIGS. 8A to 8C are diagrams for describing the mechanism with which a recording mark is deformed by the integration of adjacent holes.

### DESCRIPTION OF THE PREFERRED EMBODIMENTS

Embodiments of the present invention will now be described, but the present invention is not limited to the following embodiments.

The description is made in the order below.

1. Embodiment of optical information recording medium
2. Embodiment of method for producing optical information recording medium

### <1. Embodiment of Optical Information Recording Medium>

### [Structure of Optical Information Recording Medium]

An optical information recording medium according to an embodiment of the present invention will now be specifically described.

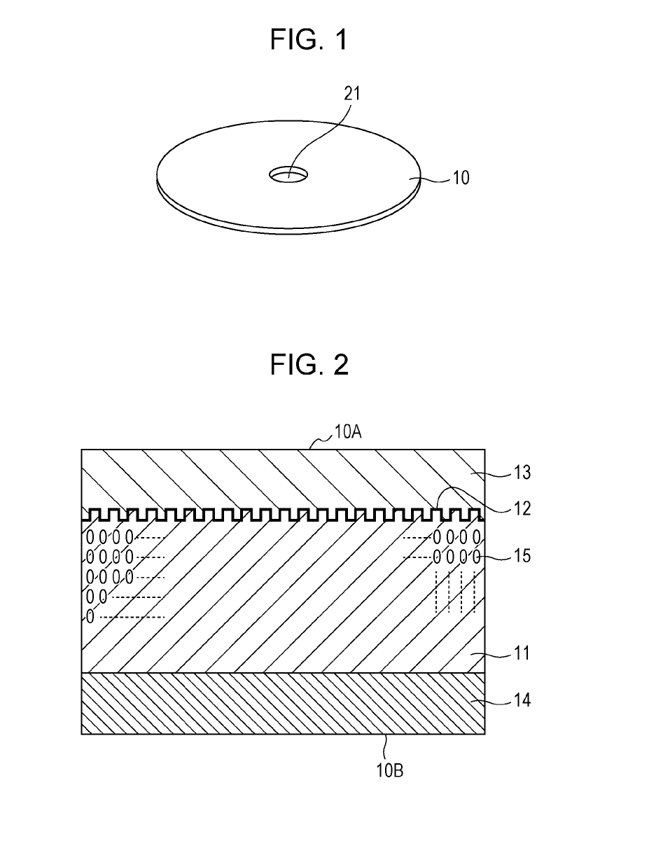

FIG. 1 schematically shows an optical disc, which is an example of the optical information recording medium according to this embodiment.

An optical disc 10 serving as an optical information recording medium substantially has a disc shape as a whole, and an opening 21 for chucking is formed in the center of the optical disc 10.

FIG. 2 is a sectional view for describing the structure of the optical disc 10. As shown in FIG. 2, the optical disc 10 includes a recording layer 11 for recording information, a cover layer 13 for covering one surface of the recording layer 11, and a substrate 14 for covering the other surface of the recording layer 11. The optical disc 10 also includes a reference layer 12 formed between the recording layer 11 and the cover layer 13.

In the recording layer 11, recording marks 15 composed of holes formed by irradiation with a light beam are formed at arbitrary positions. The recording marks 15 are formed so as to be a single layer in the reproduction direction of the optical disc. A plurality of layers including the recording marks 15 are formed in the depth direction.

Although the case where the reference layer 12 is formed on the incident side of the optical disc 10 has been described, the reference layer 12 can be formed on the side opposite the incident side, that is, on the second surface 10B side. Furthermore, the recording layer 11 is divided into recording sub-layers and a plurality of reference layers 12 can be formed between the recording sub-layers. The number of the reference layers 12 to be formed is preferably one or two in consideration of production cost or the like.

The reference layer 12 is, for example, formed by disposing a dielectric film on a guiding groove for servo formed using a stamper or the like. The dielectric film has a five-layer structure of silicon nitride/silicon oxide/silicon nitride/silicon oxide/silicon nitride, for example. Herein, for example, the thickness of silicon nitride is set to be 80 [nm] and the thickness of silicon oxide is set to be 110 [nm]. This allows the dielectric film to reflect light with a wavelength of about 650 [nm] and substantially transmit 100 [%] of light with a wavelength of about 400 [nm].

The dielectric film can be composed of various materials having different refractive indexes, such as tantalum oxide, titanium oxide, magnesium fluoride, and zinc oxide, in addition to silicon nitride and silicon oxide. The materials of the dielectric film can be suitably selected in accordance with the wavelengths of a servo light beam LS and an information light beam LM.

The cover layer 13 is composed of various optical materials such as a glass substrate, an acrylic resin, and a polycarbonate resin and transmits light at a high transmission rate.

The recording layer 11 preferably has a thickness of 0.05 [mm] or more and 1.2 [mm] or less. If the thickness of the recording layer 11 is decreased, it is difficult to arrange many of the recording marks 15 in the thickness direction of the recording layer 11, which causes difficulties in increasing the recording capacity of the optical disc 10. If the thickness of the recording layer 11 is more than 1.2 [mm], the spherical aberration of the light beam applied is unfavorably increased at a deeper position.

The total thickness of the cover layer 13 and the recording layer 11 that transmit light is preferably 1.0 [mm] or less. If the thickness is more than 1.0 [mm], the astigmatism of a light beam for recording caused in the optical disc 10 is increased when the surface of the optical disc 10 is inclined.

An antireflection coating (AR) treatment with a four-layer inorganic layer (Nb₂O₂/SiO₂/Nb₂O₅/SiO₂) or the like that does not reflect an incident light beam may be performed on the outer surface (the surface that does not contact the recording layer 11) of the cover layer 13.

The optical disc 10 does not necessarily include the substrate 14 on the second surface side of the recording layer 11. By providing the substrate 14, the recording layer 11 can be protected and thus the optical disc 10 can be easily handled. The physical strength of the optical disc 10 depends on the materials and thicknesses of the substrate 14 and the cover layer 13.

In the optical disc 10, by forming a plurality of intermediate layers in the recording layer 11, a plurality of recording layers 11 can be formed.

A groove forming layer may also be formed between the recording layer 11 and the reference layer 12. The groove forming layer is formed by pasting a photocurable or thermosetting pressure-sensitive adhesive sheet on the cover layer 13 and then by transferring a stamper onto the pressure-sensitive adhesive sheet. Reference layers 12 may be formed on both sides, that is, on the first surface 10A side and the second surface 10B side, and light beams may be incident from both the first surface 10A and second surface 10B.

Furthermore, adhesive layers may be formed between the recording layer 11 and the substrate 14 and between the reference layer 12 and the cover layer 13.

As described above, the optical disc 10 includes the reference layer 12 on the incident surface side, with respect to the recording layer 11, from which an information light beam is incident. Thus, in the optical disc 10, the depth from a reference surface and the depth from a surface can be caused to agree with each other, and therefore the spherical aberration according to the depth from a reference surface can be typically fed to an information light beam. As a result, in an optical disc device, by correcting the spherical aberration according to the depth from a reference surface, the spherical aberration of the information light beam can be accurately corrected, which can improve the recording/reproducing characteristics of the optical disc 10.

### [Recording/Reproducing Principle of Optical Disc]

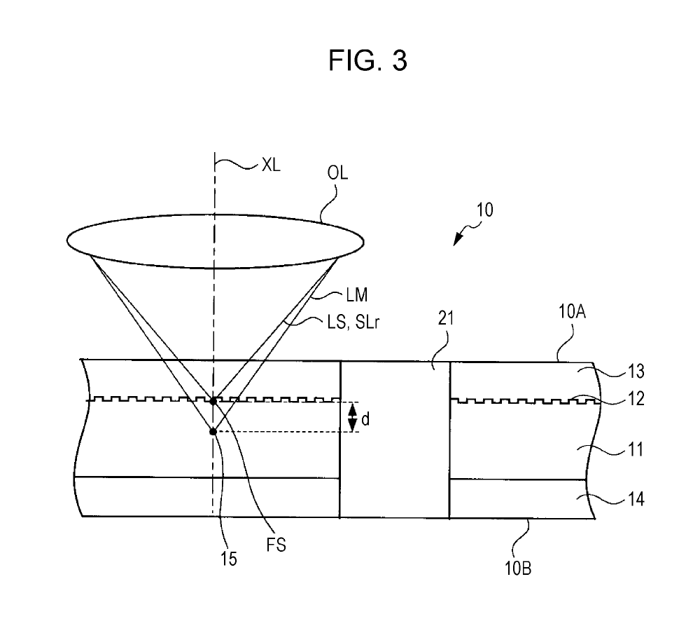

The recording/reproducing principle of the recording marks 15 in the optical disc 10 will now be described with reference to FIG. 3. As shown in FIG. 3, in the optical disc 10, a light beam is incident from the first surface 10A that is a surface of the cover layer 13.

The reference layer 12 has a guiding groove for servo formed therein. The guiding groove has a spiral track (servo track) TR formed of, for example, the same groove and land as those of typical BD-R (recordable) discs. The widths of the groove and land are selected in accordance with the wavelength of an information light beam LM for recording and reproducing information. For example, assuming that the wavelength of the information light beam LM is 650 [nm], a groove and land each having the same width as that in DVD (digital versatile disc)-Rs can be used. Assuming that the wavelength of the information light beam LM is 405 [nm], a groove and land each having the same width as that in BDs (Blu-ray discs, registered trademark) can be used. As in DVD-RAMS (random access memory), a groove and land may each have the same width as that of a track pitch.

A servo track TS has a serial number for every predetermined recording bit, the number serving as an address. A servo track (hereinafter referred to as a target servo track TSG) to be irradiated with a light beam for servo (servo light beam LS) is specified by the address.

The optical disc 10 is irradiated with the information light beam LM and the servo light beam LS. The reference layer 12 transmits the information light beam LM at a high transmission rate and reflects the servo light beam LS at a high reflection rate. For example, a blue-violet light beam with a wavelength of about 405 [nm] is used as the information light beam LM. For example, a red light beam with a wavelength of about 660 [nm] is used as the servo light beam LS.

When the optical disc 10 is irradiated with the servo light beam LS through an objective lens OL of the optical disc device, the servo light beam LS is reflected by the reference layer 12 and emitted from the cover layer 13 side as a reflected servo light beam LSr. The reflected servo light beam LSr is received by the optical disc device (not shown). The optical disc device then controls the position of the objective lens OL in a focusing direction in accordance with the received light beam. Thus, the focal point FS of the servo light beam LS is located in the reference layer 12.

When the optical disc 10 is irradiated with the information light beam LM through the objective lens OL, the information light beam LM is transmitted through the cover layer 13 and the reference layer 12 and the recording layer 11 is irradiated with the information light beam LM. At this time, the optical disc device makes the optical axes of the servo light beam LS and the information light beam LM substantially coincide with each other. Thus, the focal point FM of the information light beam LM is located on a normal line XL that is perpendicular to the focal point FS of the servo light beam LS in the reference layer 12. Hereinafter, a track corresponding the target servo track TSG in a target mark layer YG is referred to as a target track TG, and the position of the focal point FM is referred to as a target position PG.

In the case where the recording layer 11 is composed of a photoreactive resin that reacts with a blue-violet light beam having a wavelength of 405 [nm], when the recording layer 11 is irradiated with the information light beam LM for recording (hereinafter referred to as recording information light beam LMw), an air bubble or the like is generated at the position of the focal point FM through the boiling or decomposition of the photoreactive resin. The generation of the air bubble or the like forms the recording mark 15 composed of a hole in the recording layer 11. The photoreactive resin will be specifically described later.

In the optical disc device, for example, information to be recorded is encoded into binary recording data that is a combination of the characters “0” and “1”. In the optical disc device, for example, the emission of the recording information light beam LMw is controlled so that the recording mark 15 is formed so as to correspond to the character “1” of the recording data and the recording mark 15 is not formed so as to correspond to the character “0”.

Furthermore, in the optical disc device, the intensity of the recording information light beam LMw is modulated while the optical disc 10 is rotated and the objective lens OL is properly moved in the radial direction in a controlled manner. In the recording layer 11 of the optical disc 10, a spiral track including a plurality of recording marks 15 is sequentially formed at a position corresponding to the servo track TS formed on the reference layer 12.

The recording marks 15 are formed in a plane substantially parallel to the surfaces such as the first surface 10A and the reference layer 12 of the optical disc 10. Therefore, a layer having the recording marks 15 formed in a plane, a so-called mark layer, is formed in the recording layer 11.

By changing the position of the focal point FM of the recording information light beam LMw in the thickness direction of the optical disc 10, a plurality of mark layers can be formed in the recording layer 11. For example, by sequentially forming mark layers at certain intervals in the thickness direction of the optical disc from the first surface 10A side of the optical disc 10, a plurality of mark layers can be formed in the recording layer 11.

When information is reproduced from the optical disc 10, an information light beam LM for reproduction (readout information light beam LMi) having relatively low light intensity is condensed from the first surface 10A side. When a recording mark 15 is formed at the position of the focal point FM, that is, at the target position PG, the readout information light beam LMi is reflected by the recording mark 15 and becomes a reflected information light beam LMr.

The optical disc device generates a detection signal in accordance with a detection result of the reflected information light beam LMr, and detects whether a recording mark 15 has been formed on the basis of the detection signal. In the optical disc device, for example, the case where the recording mark 15 has been formed is assigned as the character “1” and the case where a recording mark 15 is not formed is assigned as the character “0”. In such a manner, the information recorded through encoding in the form of binary recording data can be reproduced.

As described above, in the optical disc device, by irradiating the target position PG with the information light beam LM using the servo light beam LS together, information is recorded in the recording layer 11 or reproduced from the recording layer 11.

In the above-described optical disc, instead of the guiding groove, pits or the like may be formed on the reference layer 12 (i.e., the boundary surface between the recording layer 11 and the cover layer 13). The guiding groove and the pits or the like may be formed in combination. The track of the reference layer 12 is not necessarily spirally formed, but may be concentrically formed.

### [Configuration of Recording Layer]

The configuration of the recording layer 11 of the above-described optical disc 10 will be described.

The recording layer 11 is composed of a photoreactive thermoplastic resin and particles of an inorganic oxide dispersed in the thermoplastic resin. When the photoreactive thermoplastic resin is irradiated with a condensed recording information light beam LMw, a recording mark 15 composed of a hole is formed near the focal point FM of the recording information light beam LMw.

### [Configuration of Thermoplastic Resin]

First, a thermoplastic resin that constitutes the recording layer 11 of the optical disc 10 will be described.

The thermoplastic resin that constitutes the recording layer 11 is a photoreactive resin in which the recording mark 15 is formed through multiphoton absorption reaction. In the multiphoton absorption reaction, only light near the focal point FM where the recording information light beam LMw has significantly high light intensity is absorbed to cause a photoreaction.

Therefore, the recording layer 11 composed of the thermoplastic resin hardly absorbs the recording information light beam LMw at a position other than the vicinity of the focal point FM, and thus the recording information light beam LMw can reach a deep position while the light intensity of the recording information light beam LMw is not attenuated.

Part of the photoreactive thermoplastic resin is evaporated through boiling or decomposition caused by the heat generation according to the photoreaction, and thus a recording mark 15 composed of a hole is formed near the focal point FM. Herein, the thermoplastic resin is selected in consideration of the recording speed, the size, shape, and position of the recording mark 15, and the recording characteristics such as the stability of the recording mark 15.

In a one-photon absorption reaction in which a single photon is absorbed to cause a photoreaction, when a recording mark 15 is formed by changing the light intensity of the recording information light beam LMw, the recording speed is normally decreased in substantially inverse proportion to the light intensity. This is because the probability of a photoreaction is in proportion to the number of photons.

On the other hand, in a two-photon absorption reaction in which two photons are absorbed to cause a photoreaction, when a recording mark 15 is formed by changing the light intensity of the recording information light beam LMw, the recording speed is decreased in substantially inverse proportion to the square of the light intensity. This is because two photons are absorbed substantially at the same time to cause a photoreaction.

Regarding the thermoplastic resin used for the optical disc 10, when a recording mark 15 is formed by changing the light intensity of the recording information light beam LMw, the recording time is preferably decreased in inverse proportion to the M-th power of the light intensity (M≧2.9, preferably M≧3.0, and more preferably M≧3.3). Thus, in the recording layer 11, a photoreaction is caused in only a portion where the recording information light beam LMw has significantly high light intensity.

The recording layer 11 is mainly composed of a thermoplastic resin that causes a multiphoton absorption reaction. The ratio of the thermoplastic resin to the entire resin that constitutes the recording layer is preferably 50% or more by mass and particularly preferably 70% or more by mass. Even if the sensitivity of the thermoplastic resin itself is low, the sensitivity of the entire recording layer 11 to multiphoton absorption can be improved by incorporating the photoreactive thermoplastic resin at a high ratio.

The thermoplastic resin is preferably a polymer having a weight-average molecular weight Mw of 10000 or more. This provides sufficiently high mechanical strength to the recording layer 11 and physically stabilizes the position of the recording mark 15 that has been formed. Thus, the recording characteristics can be improved.

The thermoplastic resin preferably has functional groups of a carbonyl group and an alkoxycarbonyl group in the structure thereof. The thermoplastic resin may have both of a carbonyl group and an alkoxycarbonyl group or may have one of a carbonyl group and an alkoxycarbonyl group in the structure thereof.

An example of the thermoplastic resin having a carbonyl group or an alkoxycarbonyl group is a polymer of a compound having a structural unit represented by general formula (1) below and a compound having a carbonyl group or an alkoxycarbonyl group.

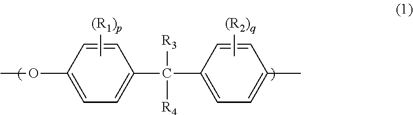

In the general formula (1), R₁, R₂, R₃, and R₄ are each independently a hydrogen atom or a substituted group and preferably a hydrogen atom, an alkyl group with 1 to 6 carbon atoms, an aryl group, a cycloalkyl group, a hydroxyl group, or an alkoxy group. Furthermore, p and q are each an integer.

An example of the structural unit represented by the general formula (1) above is a polymer or copolymer of bisphenol A. Examples of the compound having a carbonyl group or an alkoxycarbonyl group include phosgene and dibasic acids such as phthalic acid and carboxylic acid.

The thermoplastic resin is particularly preferably a resin having a structural unit represented by general formula (2) below or a resin having a structural unit represented by general formula (3) below.

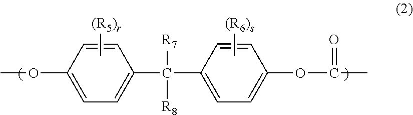

In the general formula (2) above, R₅, R₆, R₇, and R₈ are each independently a hydrogen atom or a substituted group and preferably a hydrogen atom, an alkyl group with 1 to 6 carbon atoms, an aryl group, a cycloalkyl group, a hydroxyl group, or an alkoxy group. Furthermore, r and s are each an integer.

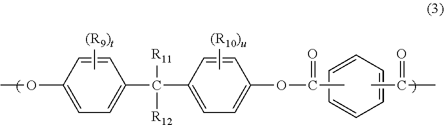

In the general formula (3) above, R₉, R₁₀, R₁₁, and R₁₂ are each independently a hydrogen atom or a substituted group and preferably a hydrogen atom, an alkyl group with 1 to 6 carbon atoms, an aryl group, a cycloalkyl group, a hydroxyl group, or an alkoxy group. Furthermore, t and u are each an integer.

The resin having the structural unit represented by the general formula (2) above is, for example, preferably a polycarbonate resin represented by general formula (4) below.

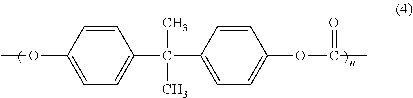

The resin having the structural unit represented by the general formula (3) above is, for example, preferably an amorphous polyarylate resin represented by general formula (5) below.

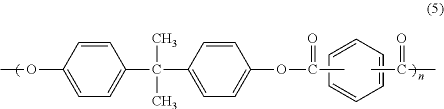

An example of the thermoplastic resin having a carbonyl group or an alkoxycarbonyl group is a resin having a structural unit represented by general formula (6) below.

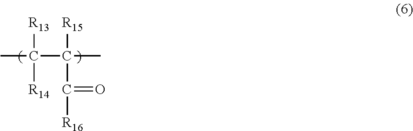

In the general formula (6) above, R₁₃, R₁₄, R₁₅, and R₁₆ are each independently a hydrogen atom or a substituted group and preferably a hydrogen atom, an alkyl group with 1 to 6 carbon atoms, an aryl group, a cycloalkyl group, a hydroxyl group, or an alkoxy group.

The resin having the structural unit represented by the general formula (6) above is, for example, preferably a methyl methacrylate resin (PMMA) represented by general formula (7) below.

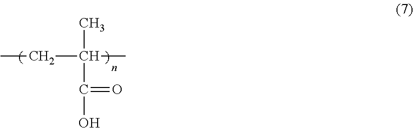

As described above, by employing, as the thermoplastic resin that constitutes the recording layer 11, a resin having a carbonyl group or an alkoxycarbonyl group in the structural unit thereof, a photoreaction can be caused only in a portion where the light intensity is significantly high and thus a satisfactory recording mark 15 can be formed.

In addition to the photoreactive thermoplastic resin and the multiphoton absorption material, the recording layer 11 may contain other components including low-molecular-weight components and various polymers that change the heat characteristics such as viscoelasticity during heating and various additives that change the characteristics during the production. The other additives are preferably added in an amount that does not significantly decrease the recording sensitivity of the recording layer 11. The mass content of the other additives is preferably less than 50% and particularly preferably less than 30% relative to the total mass of the thermoplastic resin.

### [Configuration of Inorganic Oxide]

Next, an inorganic oxide that constitutes the recording layer of the optical disc 10 will be described.

The inorganic oxide is present in the form of particles dispersed in the above-described thermoplastic resin. Therefore, the inorganic oxide preferably has substantially the same refractive index as that of the thermoplastic resin that constitutes the recording layer, or the difference in refractive index between the inorganic oxide and the thermoplastic resin is preferably small. That is, when the thermoplastic resin that constitutes the recording layer is irradiated with the recording information light beam LMw, the inorganic oxide preferably has no interference and interaction with the light beam with a certain wavelength. The particles dispersed in the resin preferably have no light absorption in the wavelength range of the recording information light beam LMw.

The particles dispersed in the resin are composed of a material having a thermal conductivity higher than that of the resin.

The particles of the inorganic oxide are preferably spherical. If the shape is not spherical, for example, the heat generated is easily nonuniformly absorbed in the state in which the particles are dispersed in the recording layer. If the shape is spherical, the heat generated during the recording can be uniformly absorbed and propagated in the recording layer.

For the reason described above, the inorganic oxide is at least one selected from Al₂O₃, SiO₂, TiO₂, and Y₂O₃, and these materials can be used alone or in combination.

Specific examples of the inorganic oxide particles include Al₂O₃, SiO₂, TiO₂, and Y₂O₃ of NanoTek (registered trademark) Powder and NanoTek (registered trademark) Slurry available from CIK Nanotek Corporation.

If the particles dispersed in the resin have a particle size smaller than or equal to a wavelength, the particles are not treated as optical impurities. Thus, the recording information light beam LMw in the recording layer is transmitted without being subjected to light scattering or interference such as diffraction caused by the inorganic oxide.

An excessively small particle size degrades the dispersibility. If the dispersibility in the resin is poor, a uniform suspension is not obtained and thus light scattering or the like resulting from the nonuniformity of a solution is unfavorably caused. An excessively large particle size is also a cause of the degradation of dispersibility in the resin.

Preferably, the maximum particle size of the inorganic oxide particles is smaller than or equal to the diffraction limit and the average particle size is sufficiently smaller than the maximum particle size.

Formula (1) below, which is a relational expression among a scattering coefficient, the wavelength of light, and a particle size, holds when the particle size is smaller than or equal to the wavelength of the light.

α=πD/λ (1)

Herein, α is a scattering coefficient, D is a particle size [nm], and λ is the wavelength of light [nm].

When the scattering coefficient α is sufficiently lower than 1 (α<<1), Rayleigh scattering is caused. When the scattering coefficient α is approximately 1 (α≅1), Mie scattering is caused. When the scattering coefficient α is sufficiently higher than 1 (α>>1), forward scattering expressed using Fraunhofer approximation is caused.

In the case of Rayleigh scattering, since the light incident onto the particles is isotropically scattered, backscattered light is generated in the rear of the particles. Thus, the light incident onto the particles reaches the rear of the particles through scattering. As a result, the light amounts in the front and rear of the particles onto which the light is incident are the same, and the scattering caused by the particles can be neglected. That is, the particles can be neglected when the incident light is taken into account.

On the other hand, in the cases of Mie scattering and forward scattering expressed using Fraunhofer approximation, there are a large amount of forward scattered light and a small amount of backscattered light. As a result, the light transmittance is decreased in the rear of the particles onto which the light is incident, and the light scattering caused by the particles is not neglected. That is, the particles are not neglected when the light is taken into account.

Thus, the particle size D of the inorganic oxide dispersed in the resin is selected so that the scattering coefficient α is sufficiently smaller than 1.

In the case of α<<1, formula (2) below is obtained by modifying the formula (1) above.

D<<λ/π (2)

Herein, for example, when the recording layer is irradiated with a blue-violet light beam having a wavelength of 405 nm, D<<405/π and thus D<<128.91.

That is, when light having a wavelength of 405 nm is used, the maximum particle size of the inorganic oxide particles is set to be 128.91 nm and the average particle size is set to be within a range that is sufficiently smaller than 128.91 nm. Specifically, the maximum particle size of the inorganic oxide particles is set to be 128.91 nm, and the average particle size is set to be 100 nm or less and preferably 64 nm or less, which is less than half the maximum particle size.

Although the particle size of the inorganic oxide depends on the wavelength of light used, the upper limit of the particle size can be determined in accordance with the wavelength of light using the formula (2) above. Specifically, the maximum particle size of the inorganic oxide particles can be set to be the wavelength of light used λ/π, and the average particle size can be set to be smaller than λ/π and preferably set to be within a range of λ/2π or less.

The particle size of the inorganic oxide particles is preferably 10 nm or more. If the particle size is less than 10 nm, the particles are easily aggregated, and high dispersibility is not achieved even if the surface treatment described below is performed. It is also considered to be significantly difficult to produce inorganic oxide particles having a particle size of less than 10 nm. Thus, the particle size is preferably 10 nm or more.

The inorganic oxide particles are subjected to surface treatment in order to improve the dispersibility in the thermoplastic resin. A surface-treating agent is suitably selected in accordance with the type of photoreactive resin that constitutes the recording layer.

When the thermoplastic resin including the inorganic oxide particles dispersed therein is the thermoplastic resin having a carbonyl group or an alkoxycarbonyl group in the structural unit thereof, a silane coupling agent having an amino group at the terminal thereof is preferably used. For example, the surface of the inorganic oxide is preferably modified with 3-aminopropyltriethoxysilane or 3-(2-aminoethyl)aminopropyltrimethoxysilane.

By performing surface treatment on the inorganic oxide particles with a silane coupling agent, a functional group having high affinity and compatibility with the resin is oriented on the outer surfaces of the particles. Thus, the dispersibility of the inorganic oxide particles can be improved in the thermoplastic resin or an organic solvent.

The inorganic oxide is preferably added to the resin in an amount that achieves the maximum concentration of the inorganic oxide which can be added in the production process of the recording disc. Since the heat generated during the recording can be further absorbed or spread as the amount of the inorganic oxide particles added is increased, the diameter of holes (recording marks) can be decreased and thus the integration of adjacent holes caused by melting can be prevented.

The maximum concentration of the inorganic oxide particles that can be added in the production process is a maximum concentration of the inorganic oxide particles that can be dispersed in an organic solvent. For example, the maximum concentration of the inorganic oxide particles dispersed in an organic solvent is set to be 10% by mass. In consideration of ease of coating performed when the recording layer is formed, the concentration of the thermoplastic resin dissolved in the organic solvent is preferably 10 to 20% by mass. Since the organic solvent is completely removed by heating performed when the recording layer is formed, only the thermoplastic resin and inorganic oxide are present in the recording layer. Thus, the maximum amount of the inorganic oxide added to the thermoplastic resin can be expressed as follows.

{M_{NPs}/(M_{NPs}+M_{poly})}×100 (3)

M_{NPs} is the maximum weight of the inorganic oxide and M_{poly} is the minimum weight of the resin.

For example, in the case where tetrahydrofuran (THF) is used as the organic solvent, assuming that the density of THF is 0.888 g/cm³ and the minimum concentration of the resin is 10%, the minimum weight M_{poly} of the resin can be represented by the following formula.

M_{poly}=Vₛₒₗᵥ×0.888×0.1

Vₛₒₗᵥ is the volume of THF.

Furthermore, the maximum weight M_{NPs} of the inorganic oxide can be represented by the following formula.

M_{NPs}=Vₛₒₗᵥ×0.888×0.1

Since M_{poly} and M_{NPs} have the same right-hand side, M_{poly}=M_{NPs}. Therefore, by substituting M_{poly}=M_{NPs} in the formula (3) above, the formula that represents the maximum amount of the inorganic oxide added to the thermoplastic resin can be simplified to be as follows.

{M_{Nps}/(M_{Nps}+M_{poly})}×100=M_{NPs}/2(M_{NPs})×100 (4)

Thus, the maximum amount of the inorganic oxide added to the thermoplastic resin is 0.5×100=50 (% by mass). Note that the 50% by mass is the maximum amount of the inorganic oxide that can be added to the resin in the production process. Thus, in the production process of the recording disc, the amount of the inorganic oxide added to the resin of the recording layer has to be 50% or less by mass. For example, the amount is preferably 25% or less by mass to achieve sufficient transmittance of the recording layer. The amount of the inorganic oxide added to the resin is within a range of 50% or less by mass and is determined in consideration of the characteristics or the like demanded for the recording disc.

Moreover, when a recording mark having the maximum diameter is formed in the recording layer, the inorganic oxide is preferably added to the resin in an amount that achieves a certain concentration or higher at which at least one of the particles is dispersed in the recording mark. For example, the diameter of the recording mark is assumed to be 100 to 200 nm and the average particle size of the inorganic oxide particles is assumed to be 10 to 100 nm. In the case where the maximum concentration of the resin is, for example, 20%, the volume (V_{rec}) of the recording layer is about 20% of the volume (Vₛₒₗᵥ) of a solvent.

In this case, the volume V_{rec} of the recording layer can be represented by the following formula (5) below.

V_{rec}=0.2Vₛₒₗᵥ (5)

Assuming that the concentration (NPs concentration) of the inorganic oxide in the recording layer is x % by mass, the number (N_{NPs}) of the inorganic oxide particles contained in Vₛₒₗᵥ can be represented by the following formula.

N_{NPs}=Vₛₒₗᵥ×0.888×(x/100)×(1/NPs density)×(1/N_{NP}) (6)

Note that N_{NP} is the volume of a single inorganic oxide particle.

Herein, (Vₛₒₗᵥ×0.888×(x/100)) indicates the total weight of the inorganic oxide in the solvent. In addition, (Vₛₒₗᵥ×0.888×(x/100)×(1/NPs density)) indicates the total volume of the inorganic oxide in the solvent.

Assuming that the average radius of the inorganic oxide particles is r_{NP}, the volume (N_{NP}) of a single inorganic oxide particle can be represented by the following formula.

N_{NP}=(4/3)×π×r_{NP}³ (7)

The NPs density in the formula (6) above can be represented by (N_{NPs}/V_{rec}).

Assuming that the radius r of the recording mark is 200 nm, when at least one of the inorganic oxide particles is present in the mark, the following formula (8) is obtained from the formula (4) above and the volume of the recording mark.

(N_{NPs}/V_{rec})×(4/3)×π×200³=1 (8)

The formula (8) above indicates that, in the NPs density (N_{NPs}/V_{rec}), the number (N_{NPs}) of the inorganic oxide particles that are present in the recording mark with a radius of 200 nm is one.

By substituting the formulas (5) to (7) above in the formula (8) above, the following formula (9) is obtained.

$$\frac{{V}_{Solv} \times 0.888 \times \frac{x}{100} \times \frac{1}{NPs Density}}{{V}_{Solv} \times 0.2} \times \frac{1}{\frac{4}{3} \times π \times {r}_{NP}^{3}} \times \frac{4}{3} \times π \times {200}^{3} = 1 \qquad ( 9 )$$

The following formula (10) can be obtained by rewriting the formula (9) above with respect to x.

$$x = \frac{0.2 \times {r}_{NP}^{3} \times NPs Density}{{200}^{3} \times 0.888} \times 100 \qquad ( 10 )$$

In the formula (10), for example, there is given a solution in the case where Al₂O₃ having a true density (NPs density) of 3.5 g/cm³ and an average particle size (r_{NP}) of 31 nm is employed as the inorganic oxide. In this case, the concentration (NPs concentration)×of the inorganic oxide in the resin that constitutes the recording layer is 0.3% by mass. Thus, the amount of the inorganic oxide added to the resin in the recording layer is preferably 0.3% or more by mass.

The 0.3% by mass is the minimum amount of the inorganic oxide added when Al₂O₃ having the above-described physical properties is employed. Therefore, for example, in the case where SiO₂ having a true density (NPs density) of 2.2 g/cm³ and an average particle size (r_{NP}) of 25 nm is employed as the inorganic oxide, the concentration (NPs concentration) x of the inorganic oxide in the resin that constitutes the recording layer is 0.1% by mass. In the case where TiO₂ having a true density (NPs density) of 3.7 g/cm³ and an average particle size (r_{NP}) of 36 nm is employed as the inorganic oxide, the concentration (NPs concentration)×of the inorganic oxide in the resin that constitutes the recording layer is 0.5% by mass. In the case where Y₂O₃ having a true density (NPs density) of 5.2 g/cm³ and an average particle size (r_{NP}) of 33 nm is employed, the concentration (NPs concentration)×of the inorganic oxide in the resin that constitutes the recording layer is 0.5% by mass. In the formula above, 0.888 is the density of THF used as the solvent. Therefore, if a different solvent is used, the amount of the inorganic oxide added has to be determined using the density of the different solvent. The amount of the inorganic oxide added to the resin is preferably determined in accordance with the type and physical properties of the inorganic oxide used for the recording disc.

The inorganic oxide is subjected to surface treatment with a surface-treating agent before being dispersed in the thermoplastic resin. Therefore, in reality, the amount of the inorganic oxide to be added is the total of the weight of the inorganic oxide particles and the weight of the surface-treating agent. However, the weight of the surface-treating agent is negligibly low compared with the weight of the inorganic oxide. Therefore, the weight of the surface-treating agent on the inorganic oxide is not considered in the calculation above.

### [Advantages Achieved by Dispersion of Inorganic Oxide in Recording Layer]

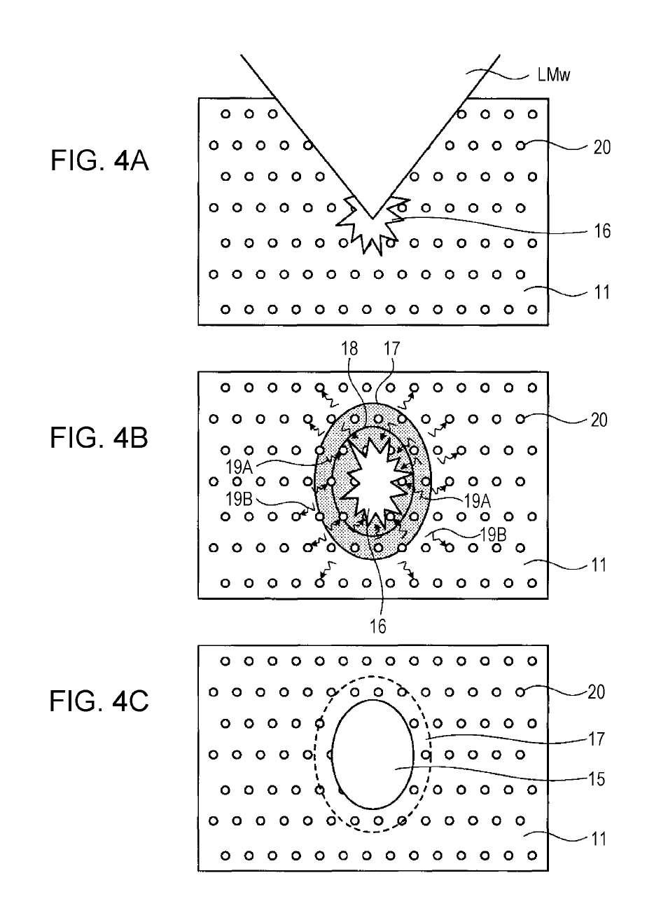

FIGS. 4A to 4C show the mechanism with which the recording mark 15 is formed, the mechanism being achieved by dispersing the inorganic oxide in the recording layer 11.

As shown in FIG. 4A, an irradiation point 16 of the recording layer 11 including the inorganic oxide particles 20 dispersed therein is irradiated with the recording information light beam LMw. Through the irradiation with the light beam LMw, the thermoplastic resin that constitutes the recording layer 11 nonlinearly absorbs light and thus a hole is formed.

Herein, as shown in FIG. 4B, the heat generated at the irradiation point 16 is propagated to the surroundings of the irradiation point 16 and a region 18 having a temperature higher than or equal to the melting temperature of the resin is formed.

The inorganic oxide dispersed in the recording layer has a thermal conductivity higher than that of typical resins. For example, the thermal conductivities [W/m·k] of a polycarbonate resin, an amorphous polyarylate resin, and a PMMA resin are 0.19, 0.24, and 0.17 to 0.25, respectively.

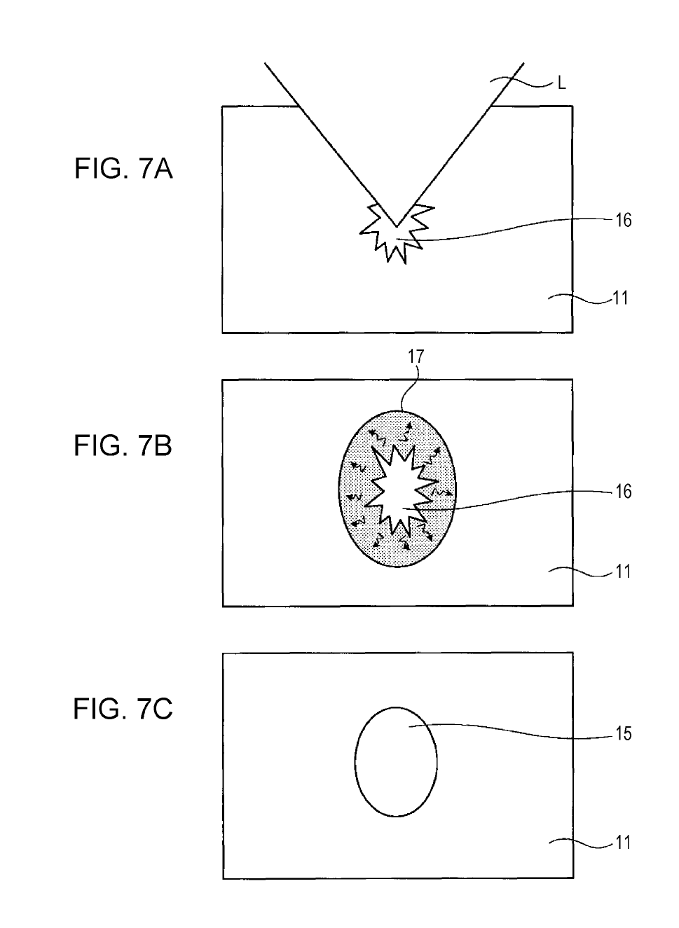

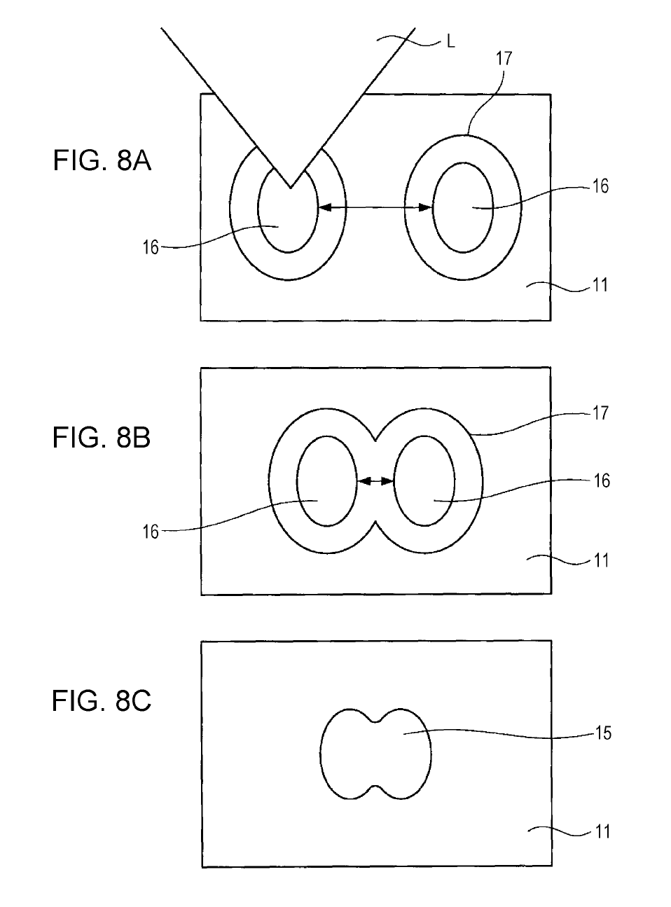

On the other hand, the thermal conductivities [W/m·k] of Al₂O₃, SiO₂, TiO₂, and Y₂O₃ are 30 to 40, 1 to 20, 8 to 9, and 10 to 20, respectively. Thus, the heat generated in the recording layer 11 through the irradiation with the recording information light beam LMw is selectively moved to the inorganic oxide as indicated by an arrow 19A. In the recording layer 11, since the amount of heat generated is selectively moved to the inorganic oxide in such a manner, the amount of heat propagated to the resin is decreased. As a result, the size of the region 18 having a temperature higher than or equal to the melting temperature of the resin is decreased compared with the size of the region 17 (FIG. 7C) having a temperature higher than or equal to the melting temperature of the resin in a recording layer that does not include the inorganic oxide.

Furthermore, by adding the inorganic oxide particles having high thermal conductivity, the heat generated at the irradiation point 16 is propagated through the inorganic oxide particles to inorganic oxide particles 20 that surround the region 17 as indicated by an arrow 19B. As a result, the heat generated at the irradiation point 16 is spread to a wider region. The heat propagated from the vicinity of the irradiation point 16 is widely spread, whereby the temperature in that region is decreased. Thus, the size of the region 18 having a temperature higher than or equal to the melting temperature of the resin in the recording layer 11 including the inorganic oxide dispersed therein is decreased compared with the size of the region 17 (FIG. 7C) having a temperature higher than or equal to the melting temperature of the resin in a recording layer that does not include the inorganic oxide.

It is believed that the recording mark 15 is enlarged up to substantially the same size as that of the region 18 having a temperature higher than or equal to the melting temperature of the resin. Therefore, in the recording layer 11 including the inorganic oxide dispersed therein, the size of the region 18 having a temperature higher than or equal to the melting temperature of the resin is decreased as described above, whereby the size of the recording mark 15 formed is also decreased. Thus, the diameter of the recording mark 15 can also be decreased.

Moreover, a decrease in the size of the region 18 having a temperature higher than or equal to the melting temperature of the resin can prevent the formation of a single continuous large recording mark 15 obtained by the integration of two adjacent holes.

The distance between two adjacent irradiation points 16 has to be maintained so that the regions 18, which have a temperature higher than or equal to the melting temperature of the resin, formed in the surroundings of the two irradiation points 16 irradiated with the light beam LMw do not overlap each other. By decreasing the size of the region 18, the positions where the regions 18 do not overlap each other can be brought closer to each other. Thus, the distance between the irradiation points 16 can be further decreased than before.

The waveform of a reproduction signal can be prevented from being deformed by the integration of two adjacent recording marks 15, whereby a desired reproduction signal can be obtained. The minimum distance between two adjacent irradiation points 16 can be further decreased than before and thus the recording marks 15 can be brought closer to each other than before.

As described above, in the optical information recording medium, by providing the recording layer including the thermoplastic resin and the inorganic oxide particles dispersed in the thermoplastic resin, the melting of the resin caused by the irradiation with the recording information light beam can be suppressed. Thus, the size of a hole can be decreased, whereby the diameter of the recording mark can be decreased. By suppressing the melting of the resin, the deformation of the recording mark caused by the integration of adjacent holes can be suppressed. Thus, there can be obtained a rectangular reproduction signal provided from multiple recording marks obtained by intermittently forming holes with a small diameter. As a result, an optical information recording medium with high density can be obtained.

### <2. Embodiment of Method for Producing Optical Information Recording Medium>

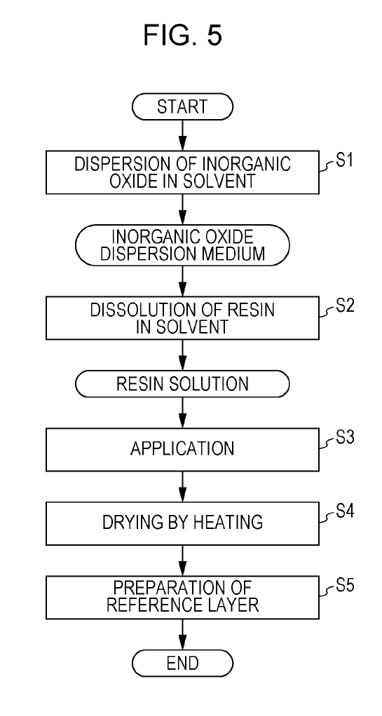

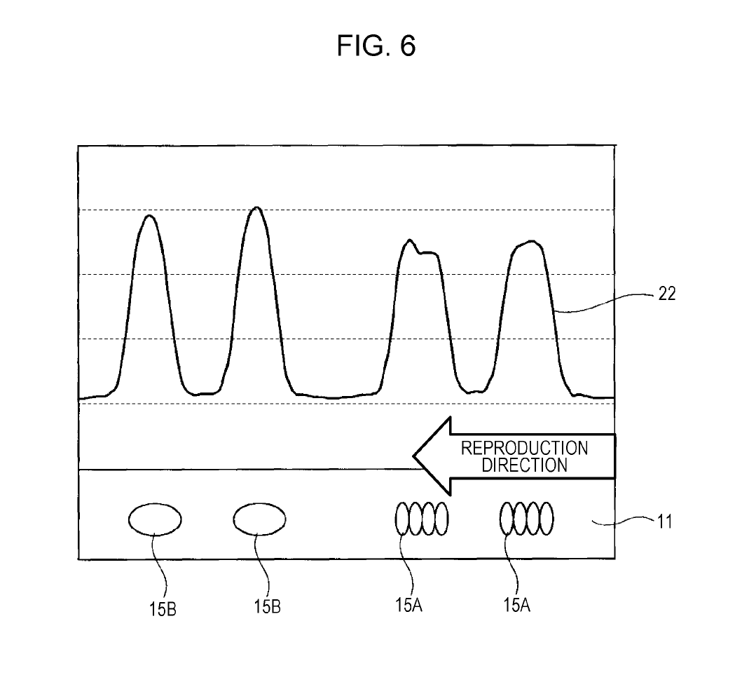

FIG. 5 is a flowchart showing a method for producing the optical disc 10 shown in FIG. 1 as an example of an optical information recording medium.

First, inorganic oxide particles are dispersed in an organic solvent (Step S1). Thus, a dispersion medium including an inorganic oxide dispersed in a solvent is prepared.

Any organic solvent can be used as long as the organic solvent can dissolve the thermoplastic resin having a carbonyl group and an alkoxycarbonyl group. Examples of the organic solvent include tetrahydrofuran (THF) and chlorinated solvents such as carbon tetrachloride, chloroform, and dichloromethane. Herein, the inorganic oxide may be surface-treated using the above-described silane coupling agent or the like to achieve the dispersibility between the particles and the dispersibility in the solvent. Examples of a material of the inorganic oxide include Al₂O₃, SiO₂, TiO₂, and Y₂O₃ as described above, and these materials can be used alone or in combination. The amount of the inorganic oxide added to the solvent is within the above-described range and is determined in consideration of the dispersibility in the solvent and the ratio of the inorganic oxide to the resin when a recording layer is formed.

Next, a thermoplastic resin is dissolved in the organic solvent including the inorganic oxide dispersed therein (Step S2). Thus, there is prepared a resin solution including the resin dissolved in the solution in which the inorganic oxide is dispersed.

The above-described resin having a carbonyl group and an alkoxycarbonyl group can be used as the thermoplastic resin. In consideration of ease of coating performed when a recording layer 11 is formed, the thermoplastic resin is dissolved so that the concentration of the thermoplastic resin in the organic solvent is 10 to 20% by mass.

Subsequently, the resin solution is applied on a substrate 14 of an optical disc 10 (Step S3). The solution that has been applied on the substrate 14 is heated to vaporize the solvent (Step S4). The application onto a substrate is performed by a typical solvent casting method. For example, there can be employed a casting method in which the resin solution including the thermoplastic resin dissolved therein is thinly flow-cast on a metal support and then the solvent is vaporized. Thus, a recording layer 11 of an optical disc 10 is prepared.

A reference layer 12 is then formed by a typical method (Step S5).

The reference layer 12 is obtained by forming, for example, the above-described dielectric film composed of silicon nitride/silicon oxide/silicon nitride/silicon oxide/silicon nitride on the recording layer by a typical method.

Furthermore, a cover layer 13 composed of an optical material such as a glass substrate, an acrylic resin, or a polycarbonate resin is optionally formed on the reference layer.

Through the steps described above, an optical disc 10 can be produced.

The present application contains subject matter related to that disclosed in Japanese Priority Patent Application JP 2010-098018 filed in the Japan Patent Office on Apr. 21, 2010, the entire contents of which are hereby incorporated by reference.

The present invention is not limited to the configurations described in the embodiments above, and various changes and modifications can be made without departing from the scope of the present invention.

What is claimed is:

1. An optical information recording medium comprising:
a recording layer,
wherein the recording layer includes
a thermoplastic resin, and
inorganic oxide particles dispersed in the thermoplastic resin.

2. The optical information recording medium according to claim 1, wherein the inorganic oxide particles are surface-treated with a silane coupling agent.

3. The optical information recording medium according to claim 2, wherein the thermoplastic resin has at least one functional group selected from a carbonyl group and an alkoxycarbonyl group in a structural unit.

4. The optical information recording medium according to claim 1, wherein the thermoplastic resin includes at least one selected from a polycarbonate resin, an amorphous polyarylate resin, and a polymethyl methacrylate resin.

5. The optical information recording medium according to claim 1, wherein the inorganic oxide includes at least one selected from Al₂O₃, SiO₂, TiO₂, and Y₂O₃.

6. The optical information recording medium according to claim 1, wherein a recording mark composed of a hole is formed in the recording layer through irradiation with light for recording.

7. A method for producing an optical information recording medium comprising the steps of:
dispersing particles of an inorganic oxide in a solvent to prepare a dispersion medium of the inorganic oxide;
dissolving a thermoplastic resin in the dispersion medium to prepare a resin solution; and
applying the resin solution on a base to form a recording layer.
